(19) United States
(12) Patent Application Publication
(10) Pub. No.: US 2006/0164240 A1
(43) Pub. Date: Jul. 27, 2006

(54) Human detection device

(76) Inventor: John Patchell, Ontario (CA)

Correspondence Address: McGUINNESS & MANARAS LLP, 125 NAGOG PARK, ACTON, MA, 01720, US

(21) Appl. No.: 10/521,203

(22) PCT Filed: Jul. 11, 2003
(86) PCT No.: PCT/CA03/01042

§ 371 Date: Jul. 5, 2005

Related U.S. Application Data
(60) Provisional application No. 60/395,124, filed on Jul. 12, 2002.

(51) Int. Cl. G08B 13/18; G08B 23/00; G08B 21/00

(52) U.S. Cl. 340/552; 340/573.1; 340/686.6

(57) ABSTRACT

A device for detecting humans includes a radio frequency transmitter for generating a signal in a frequency range in which human bodies absorb RF radiation. A radio frequency receiver is spaced relative to the radio frequency transmitter for receiving a portion of the signal. A human passageway is provided between the transmitter and receiver. The receiver includes a detector responsive to a change in the received portion of the signal for determining the passing by of a human. The detector is responsive to an amplitude and/or phase change in the received portion of the signal. A building access security system or people counting system would include a plurality of devices set up in adjacent lanes. The RF detection system may be augmented with the addition of an IR detection beam system, distance sensors and/or a video camera system. The video camera system may include stereo video.

### FIELD OF THE INVENTION

The present invention relates to human detection devices, and is particularly concerned with building access control.

### BACKGROUND OF THE INVENTION

Known systems for access control consist of pedestals that house optical (typically near-infrared) beams across a path to monitor the passage of a person. These systems are very effective in counting the number of people and can easily distinguish the direction of passage.

A major vulnerability, however, is that it is very difficult for these systems to distinguish between one person passing and two people passing side by side.

A known system (See U.S. Pat. Nos. 4,091,376, 4,562,428) uses a pair of leaky cables as antennas to detect the presence of a person in the area near the cables. These systems have been deployed outdoors for perimeter security. Another application of RF for detecting people is the use of the microwave intrusion detection systems. These systems use a microwave Tx and Rx pair and detect the passage of a person moving between the antennas when the beam is broken.

### SUMMARY OF THE INVENTION

An object of the present invention is to provide an improved human detection device.

In accordance with an aspect of the present invention there is provided a device for detecting humans comprising: a radio frequency transmitter for generating a signal; a radio frequency receiver spaced relative to the radio frequency transmitter for receiving a portion of the signal; a path therebetween sufficient for humans to pass between the transmitter and receiver. The receiver includes a detector responsive to a change in the received portion of the signal for determining the passing by of a human.

Accordingly, the present invention uses radio frequency electromagnetic waves (RF) for the detection of people. According to an aspect of the present invention there is provided a device capable of determining passage of a person between a transmit (Tx) and receive (Rx) antenna. The device is useful for monitoring the passage of people into and out of a controlled area (e.g. a building). In an embodiment of the present invention a typical separation between the Tx and Rx is from 75 to 120 cm, thus allowing passage of people, and, at the wider spacing, wheelchairs.

### BRIEF DESCRIPTION OF THE DRAWINGS

The present invention will be further understood from the following detailed description with reference to the drawings in which:

FIG. 1 illustrates in a perspective drawing a device for human detection in accordance with an embodiment of the present invention;

FIG. 2 illustrates a transmitter and transmitter antenna in accordance with an embodiment of the present invention;

FIG. 3 illustrates a specific embodiment of a folded dipole antenna;

FIG. 4 illustrates a transmitter and receiver for the device in accordance with an embodiment of the present invention;

FIG. 5 illustrates a transmitter and receiver for the device in accordance with a further embodiment of the present invention;

FIG. 6 illustrates an implementation of a shielded folded dipole antenna;

FIG. 7 illustrates a further embodiment of the present invention; and

FIG. 8 illustrates a building access system including a plurality of devices of FIG. 1.

### DETAILED DESCRIPTION OF THE PREFERRED EMBODIMENT

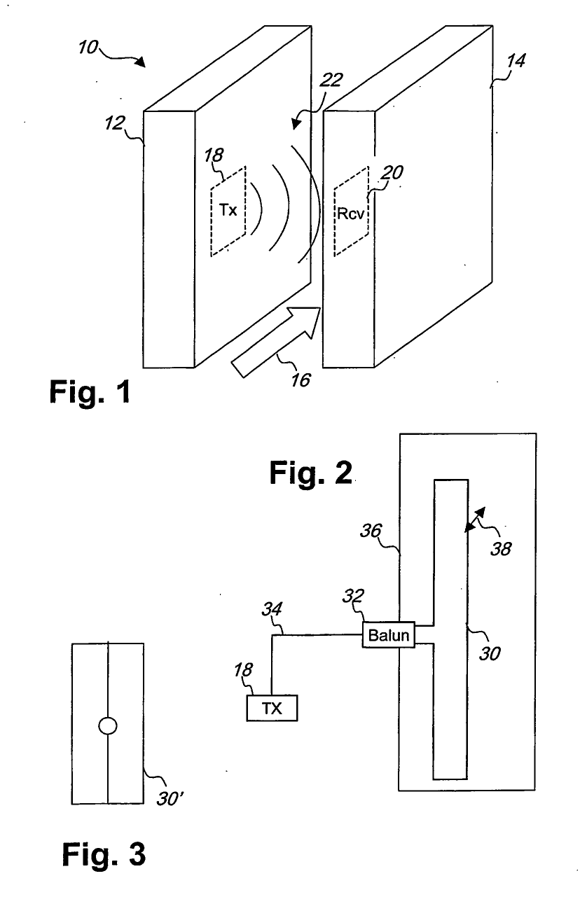

Referring to FIG. 1, there is illustrated in a perspective drawing a device for human detection in accordance with an embodiment of the present invention. The device 10 includes two plinths 12 and 14 defining a passageway with an ingress direction as indicated by an arrow 16. One pedestal, for example plinth 12, houses a transmitter 18 while the other pedestal 14 houses a receiver 20.

In operation, the transmitter 18 transmits an RF electromagnetic wave indicated generally by 22 from a transmitter antenna, not shown in FIG. 1, while the receiver 20, coupled to a receiver antenna, also not shown in FIG. 1, receives a portion of the electromagnetic waves. With no person present in the path, a relatively steady signal strength is received.

However, when a person passes through the paths, for example in direction 16, the signal strength decreases because of absorption of the signal. If two persons were to pass, an even lower signal strength would be detected. By adjusting transmitter and antenna parameters, discrimination of the device can be enhanced.

There are several important parameters for an RF detection system. Frequency of operation is an important parameter. The frequency must provide good interaction between a human body and the RF field, give a more or less uniform response independently of where a person walks through the lane (i.e. left vs. center vs. right) and it must allow the use of reasonably sized antennas. Also the frequency must fit within radio-spectrum regulations.

For a turnstile application, frequencies between about 80 and 300 MHz give a strong interaction with people. With a pedestal spacing of about 1 meter, frequencies between 100 and 200 MHz give a fairly uniform field. The pedestals are typically about 1 meter tall. If a half-wave vertical dipole is used, this indicates a frequency near 150 MHz. There is a band near this frequency that is available for licensing.

FIG. 2 illustrates a transmitter and transmitter antenna in accordance with an embodiment of the present invention. The transmitter 18 is coupled to a folded dipole antenna 30 through a balun 32 and a cable 34. A reflective metallic surface 36 is shown with the dipole antenna 30 spaced a distance 38 therefrom.

A good electric field polarization for detection of walking people is substantially vertical. An example of an antenna that gives this polarization is a 90-cm long folded dipole. This generally makes the antenna a very efficient radiator at 150 MHz and at the same time it fits nicely in a one metre high pedestal. The folded dipole is connected with a balun 32 to prevent the lead-in cables from becoming sensitive to movement.

Other types of antennas can be used. Some testing has been done with slot antennas, loop antennas and simple dipoles. Thus far the folded dipole has given the best results. Slots work almost as well but must be oriented horizontally to produce the necessary vertically polarized field. However, there is normally insufficient space, at least for one that peaks around 150 MHz. If there were bandwidth available near 200 MHz, then a horizontal slot could be a good choice.

In FIG. 3, a specific embodiment of a folded dipole antenna is illustrated. The antenna 30′ is particularly suited to the present application. The antenna 30′ is higher impedance than the folded dipoles of FIG. 2. The higher impedance is useful for matching when the antenna is close to a metal plate or in an antenna box. Making the center conductor a smaller diameter than the outer two can also raise the impedance. We have used conductors up to 0.75″ diameter and ratios between the center and outer diameters of 2:1 to 5:1. This antenna is also called a three conductor folded dipole or three element folded dipole. It is also possible to further increase the impedance by adding even more vertical elements.

Another way of accomplishing the same function as a balun 32 of FIG. 2 is to use ferrite beads on the coax cable to attenuate the currents on the outer conductor. This has been found to be a more reliable way of making sure the lead-in cable is not sensitive. Also since the three conductor folded dipoles do not need the impedance transformation the balun 32 provides, we have been able to eliminate this component by using the antenna of FIG. 3.

Multi-path and interference between adjacent lanes are considerations for this system. Multi-path can, in some cases, lead to the system receiving large signals from people walking at some distance from the path being monitored. This is particularly true in buildings where there is a large amount of metal structure. Multi-path can be controlled by introducing metal plates behind the antennas, for example, the reflective metallic surface 36 of FIG. 2. In particular, it has been found that a metal plate approximately 1 m tall×60 cm wide is sufficient to control multi-path in most situations. The exact size of the plate is not critical, and different antenna configurations may work best with other sizes of plates. The metal plates also reduce the likelihood of interference between adjacent lanes. A typical spacing 38 between the antenna and the plate is 5 cm. A further advantage of the plates is that they tend to make the detection field more uniform between the pedestals and reduce it everywhere else. The plates do not need to be solid metal. A wire mesh will do.

At the VHF frequencies (30 MHz to 300 MHz), people generally act as absorbers and attenuators of RF energy. The human body has a high dielectric constant and moderate conductivity. At the frequency of operation being used, these combine to give an RF skin depth of 5 to 20 cm. It is this combination that results in the partial absorption of the RF waves that is important to the present invention. At higher frequencies, the skin depth is much less and RF waves are simply blocked. Also the antennas being used give a very broad beam width (over 120 degrees). So even when someone is standing right next to the antenna, some of the RF energy can go around the person. It is because of these two properties (partial absorption and broad beam width) that two people have more effect than one. At lower frequencies (less than 10 MHz), there is little interaction between the human body and the RF waves so these frequencies are generally not as useful for embodiments of the present invention.

The received signal is in general reduced when someone walks between the antennas. With no person between the antennas, the signal is about −10 dB below the transmitted signal. When a person walks between the antennas, the signal goes down to about −20 dB. The exact amount of reduction depends to some extent on the size of the person (larger people reduce the signal more) and where in the lane the person walks (center vs. left or right). The variation from these two factors is approximately 1 to 3 dB. When two people try to pass side by side, the signal drops to around −27 dB and thus it is easy to determine a parallel pass by checking the amplitude of the signal.

It may turn out that some very large people may have a response similar to that of two very small people walking side by side. If this happens to be the case then a user's signatures could be registered so that when an access card is presented the system knows how large a response to expect. Different lanes would need the capability of sharing this registration information between them so that a person only needs to be registered once.

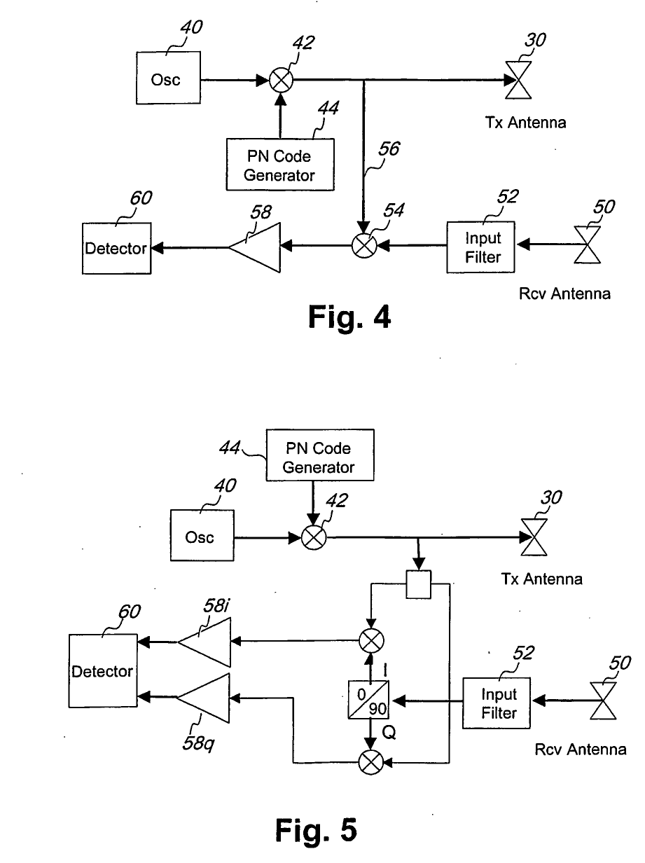

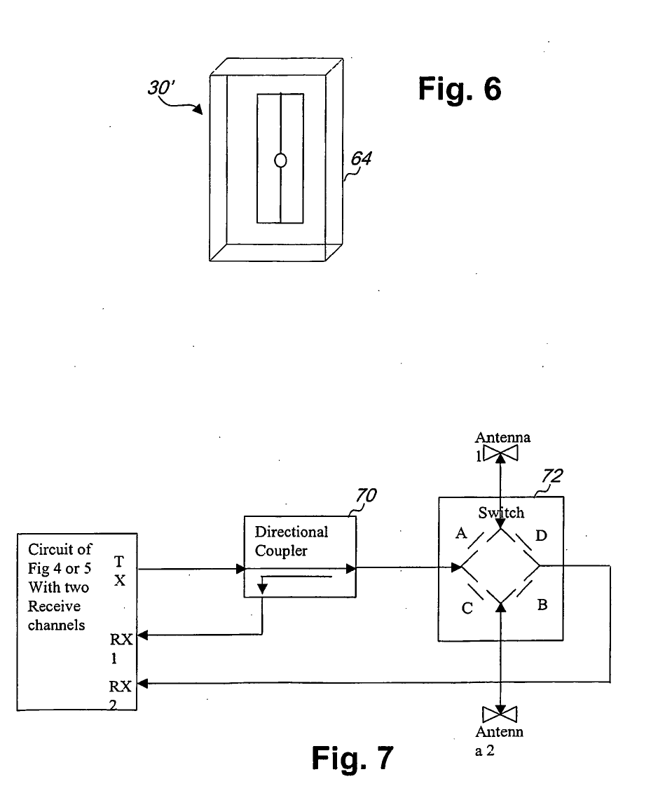

FIG. 4 illustrates a transmitter and receiver for the device in accordance with an embodiment of the present invention. The transmitter 18 includes an oscillator 40, a mixer 42, and a pseudo random number code generator 44 and a transmit antenna 30. The receiver 20 includes a receive antenna 50, an input filter 52, a mixer 54, an amplifier 58 and a detector 60. The output of the mixer 42 of transmitter 18 is coupled to the mixer 54 of receiver 20. As an alternative to the PN code generator 44, a white noise generator could be used.

To further reduce the possibility of interference, the system preferably uses spectrum spreading. This can be achieved either by frequency sweeping or by mixing the transmitted signal with a pseudo random code or white noise as in FIG. 4. If codes are used, different lanes can use different codes. A second advantage of spread spectrum is that the system can more easily come within the radio regulations for maximum field strength (150 μVolts/meter at 3 meters). And a third advantage is that spreading the spectrum makes the system less susceptible to multi-path effects (hot spots and/or dead spots). Because of current radio regulations, a good operating range for this system is 138 to 149.9 MHz. Future regulation changes may make another choice preferable.

Alternatively, as shown in FIG. 5, the receiver can include a 90-degree phase shifter plus I (In phase) and Q (Quadrature) mixers so that both the phase and the amplitude of the response can be determined. The phase information is useful in determining some types of passage. For example the phase can be used to distinguish between a wheelchair passing and a parallel pass. With amplitude only these can look very similar. In some cases, when the field is not symmetrical about the axis between the pedestals, the phase information can be used to determine the direction of passage.

A second method of determining the direction of passage uses two receive antennas and two receive channels and is based on the time delay between the two received signals. It has been found that a 30-cm spacing between the two Rx antennas is sufficient to provide reliable direction determination. Smaller separations may also be practical in some cases.

Another embodiment uses two antennas connected in parallel with a power splitter. This embodiment has the advantage of making the antennas much less sensitive to someone coming very close, but not passing through the passage. With single antennas, it is necessary to provide a space between the antenna and the closest approach of a person of up to 6 inches (about 15 cm). With double antennas separated by 4 to 12 inches (10 to 30 cm), this guard zone can be reduced. This is important in order to make the pedestals fairly thin for aesthetic reasons.

More complex systems could use multiple antennas to reduce close up sensitivity, multiple receive antennas and channels to get target direction, or even completely redundant systems to give better direction discrimination.

In some cases it may be desirable to augment the detection with antennas that produce a horizontally polarized field. These antennas could be vertical slot antennas or horizontal dipoles. Either a separate processor could be used or the horizontally polarized antennas could be connected in parallel with suitable attenuation to produce the correct sensitivity balance between the two modes. There is little interference from the horizontal antennas with the main vertically polarized field. Either a separate processor could be used or the antennas could simply be run in parallel with suitable attenuation to produce the correct sensitivity balance between the horizontal and vertical modes.

The system can also be used to monitor a doorway. For such an application, it may be useful to use two folded dipoles one above the other, or possibly a lower frequency (88 MHz to 108 MHz could be a suitable band) with a longer antenna. For doorways with metal frames, it will be necessary to have the antenna stood off by a few cm. Further tests would be needed to determine the operation of the system with a metal door.

Because of the metal plates 36, the system operation is fairly independent of nearby metal objects or people walking near the pedestals. It may be advantageous to add metal shields at the end of the pedestals to further reduce the effect of people standing just outside the lane. As illustrated in FIG. 6, we have found that putting the antennas in a rectangular metal box 64 open on one side (approximate dimensions 22″×38″×3″ deep) helps to isolate the antenna from effects of turnstile wiring and other components. It also helps in making the antenna more directional.

A concern of the other embodiments is that when a person comes close enough to one of the antennas the person can produce a similar response to that of a parallel pass. One way to ensure a separation between the person and the antenna is setting the antenna back into the turnstile. A setback of 4 to 6 inches means that the trunstiles have to be thick enough to accommodate up to 12 inches for multilane applications.

It is possible to overcome this problem, however, by measuring the signal reflected from each antenna in addition to the signal coupled between the two antennas.

Referring to FIG. 7 there is illustrated a further embodiment of the present invention. In addition to the components of FIGS. 4 and 5, a directonal coupler 70 and switch 72 are added as shown in FIG. 7 to facilitate the measurement of reflected signal. The function of the directional coupler 70 is to separate the signal reflected from the antenna from the transmitted signal.

The relected signal from both antennas must be measured to tell if a person is standing near to either antenna. To do this the system alternately transmits on one antenna and then on the other. This has no effect on the coupled signal going into RX2 as the coupling is the same independently of which antennas are transmitting and receiving. The reflected signal goes into RX1 and alternates between the two antennas. At one instant in time switches A and B of switch 72 are closed. Then they open and switches C and D close. The switching rate should be 20 Hz or greater to get adequate time resolution.

In this way, the difference between a parallel pass and a single person near one antenna is very distinct. When a person gets near one antenna the impedance changes to some extent. Some types of antennas show a much bigger change than others but they all do it. Generally the impedance increases for a close approach. Just putting a hand out near the antenna has a much smaller effect than putting the whole body near the antenna so it possible to distinguish between someone standing near the antenna and someone holding a hand out near the antenna.

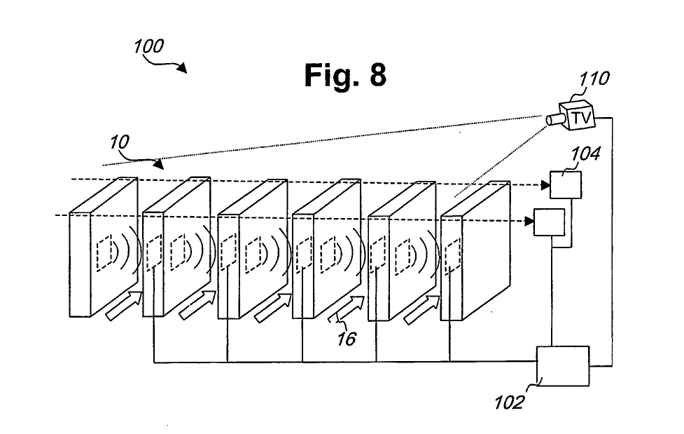

FIG. 8 illustrates a building access system 100 including a plurality of devices of FIG. 1. The devices 10 define a plurality of access paths 16. Detection signals from each receiver are routed to an access controller 102. In addition to RF detection, the building access system 100 may also include IR beam detection 104 and video surveillance 110.

Known technology used for access control employs a number of infrared beams across the lane. When these beams are broken the signals are processed to determine the direction of passage and other parameters. As can be appreciated by those of ordinary skill, the information from the light beams could combine with the data from embodiments of the present invention to get an overall estimate of what is happening. For example, if the beams were blocked with a large piece of cardboard any number of people could pass without being detected by the light beams. However, if combined with the RF system according to embodiments of the present invention, these people would be detected. Or if a number of people were standing near the pedestals, there might be enough response for the RF system to indicate someone was in the lane but the IR information could be used to determine that this was not the case. Another type of sensor that could provide useful information to complement the data from the RF is a capacitance sensor. These sensors could be used for example to determine how close a person is to the antenna and to adjust the threshold accordingly.

Similarly, the information from the RF system could be combined with data from video sensors, distance measuring sensors and/or a stereo video system. A video system may be used simply for alarm assessment or for determining more information about the person passing through the turnstile. Sensors that can provide distance information either based on ranging or stereo vision might be particularly useful. Two logical positions for cameras would be looking straight down on the lane from above or in front of and behind the person entering the lane. Current access control sensors based on video processing can be fooled relatively easily. Addition of information from the RF system described in this patent could improve their performance dramatically.

Because of the pseudo random code based spread spectrum receiver we use, any interfering signals appear like random noise added to our signal. As will be appreciated by one of ordinary skill in the art, a circuit can be added to detect the presence of RF interference. As it is not always possible to ignore interference, a strong enough signal that is close enough in space and frequency will cause false responses. But is possible to detect and warn the user when this is happening. The system can also adapt the system time constants to filter out the effect of interference up to a certain level.

Because the system uses spread spectrum, an the interfering signal must be a lot stronger than the normally received signal for it to have any effect on system performance. So it is possible to detect the interfering signal, track it in frequency, amplitude and phase and then use the resulting signal to cancel out the effect of the interference. The circuit would include a phase-locked loop to track phase and frequency, an amplitude demodulator and a subtracting circuit. The bandwidth of the phase-locked loop would need to be high enough to track any FM modulation on the interfering signal but low enough not to respond to the spreading signal.

1-27. (canceled)

28. A device for detecting humans comprising:
a radio frequency transmitter for generating a signal;
a radio frequency receiver spaced relative to the radio frequency transmitter for receiving a portion of the signal;
a path there between sufficient for humans to pass between the transmitter and receiver; and
a receiver that includes a detector responsive to a change in the received portion of the signal for determining the passing by of a human.

29. A device as claimed in claim 28 wherein the radio frequency transmitter and receiver are each housed in a pedestal.

30. A device as claimed in claim 29 wherein the path comprises a lane defined by spacing between the pedestals.

31. A device as claimed in claim 28 wherein the radio frequency transmitter includes a first antenna for generating a vertically polarized radio frequency signal.

32. A device as claimed in claim 28 wherein the first antenna comprises a dipole antenna.

33. A device as claimed in claim 28 wherein the first antenna comprises a folded dipole antenna.

34. A device as claimed in claim 28 further comprising a second antenna for generating a horizontally polarized signal.

35. A device as claimed in claim 34 wherein the second antenna comprises a dipole antenna.

36. A device as claimed in claim 34 wherein the second antenna comprises a folded dipole antenna.

37. A device as claimed in claim 28 wherein the radio frequency transmitter includes a first and a third antenna.

38. A device as claimed in claim 37 wherein the first and third antennas comprise a dipole antenna.

39. A device as claimed in claim 37 wherein the first and third antennas comprise a folded dipole antenna.

40. A device as claimed in claim 38 further comprising a second antenna for generating a horizontally polarized signal.

41. A device as claimed in claim 37 wherein first and third antennas are coupled to a single transmitter.

42. A device as claimed in claim 37 wherein first and third antennas are coupled to separate transmitters.

43. A device as claimed in claim 28 further comprising a metallic reflector is positioned behind each antenna relative to the path.

44. A device as claimed in claim 28 wherein the detector responds to a change in the amplitude of the received signal.

45. A device as claimed in claim 28 wherein both the phase and amplitude of the received signal are used in making a determination.

46. A building-access security system comprising a plurality of devices as claimed in claim 28.

47. A people-counting system comprising a plurality of devices as claimed in claim 28.

48. A building-access security system comprising a video camera system and a plurality of the devices as claimed in claim 28.

49. A building-access security system comprising a plurality of devices as claimed in claim 28, each further comprising an IR detection beam system.

50. A building-access security system comprising a plurality of the devices as claimed in claim 28, each device further comprising distance sensors.

51. A building-access security system as claimed in claim 49 further comprising a video camera system.

52. A building-access security system as claimed in claim 51 wherein the video camera system includes stereo video.

53. A device as claimed in claim 28 wherein the device includes a capacitance sensor.

54. A device as claimed in claim 28 wherein the transmitter and receiver are operable to provide a spread spectrum signal.
